(19) United States
(12) Patent Application Publication
(10) Pub. No.: US 2006/0221181 A1
(43) Pub. Date: Oct. 5, 2006

(54) Video ghost detection by outline

(75) Inventor: Maurice V. Garoutte, Dittmer, MO (US)

Correspondence Address: GREENSFELDER HEMKER & GALE PC, SUITE 2000, 10 SOUTH BROADWAY, ST LOUIS, MO, 63102, US

(73) Assignee: CERNIUM, INC., St. Louis, MO (US)

(21) Appl. No.: 11/393,430

(22) Filed: Mar. 30, 2006

Related U.S. Application Data
(60) Provisional application No. 60/666,482, filed on Mar. 30, 2005.

(51) Int. Cl. H04N 7/18

(52) U.S. Cl. 348/143

(57) ABSTRACT

Video image ghost detection in a security/surveillance CCTV system for automated image analysis. At least one pass of a video frame produces a terrain map with video content-indicating parameters, by which are analyzed behavior of objects, e.g., people and vehicles, moving in a scene having a background and a foreground, while detecting “ghost” images of objects that were in an adaptive background of the scene but are moving, by measuring a horizontal smoothness and/or vertical smoothness by segmentation procedure by which an object outline is predicted. The examination of segmented background and foreground image portions is conducted by software process to determine existence of such outline as by edge detection or changes in texture. Probability of an image ghost in either the background or foreground, or both, is calculated.

### CROSS-REFERENCE TO RELATED APPLICATION

This application claims the priority of U.S. provisional patent application Ser. No. 60/666,482, filed Mar. 30, 2005, entitled VIDEO GHOST DETECTION BY OUTLINE.

### BACKGROUND OF THE INVENTION

The invention relates to the field of intelligent video surveillance and, more specifically, to a surveillance system, i.e., a security system, that analyzes the behavior of objects such as people and vehicles moving in a video scene while detecting “ghost” images to take them into account.

Intelligent video surveillance connotes the use of processor-driven, that is, computerized video surveillance involving automated screening of security cameras, as in security CCTV (Closed Circuit Television) systems.

The invention is useful especially in a system that provides automatically screening of CCTV cameras, as used for example in parking garages. In such video-monitored security system, video data is picked up by any of many possible video cameras. It is processed by software control of the system before human intervention for an interpretation of types of images and activities of persons and objects in the images. The system can detect the difference, for example, between human subjects (pedestrians) and vehicles. It can detect whether such subjects and vehicles are moving, have stopped moving, or are moving in a certain manner, certain characteristic, or certain direction. It is important for the system to be able accurately to discriminate among such differences.

In such a CCTV system, for reasons of data handling and storage and economy of processing of digital images in camera scenes, background images may be updated less frequently than foreground image; and background images may be archived with lower resolution (using greater compression) than foreground images.

Intelligent video applications can track moving objects by detecting the differences between the current view of a CCTV camera and a background image. The analysis step of creating the background image from a series of video frames is referred to as background maintenance. The analysis step of comparing the current view to the background is referred to as segmentation. The accuracy of any intelligent video system is limited by the accuracy of the background maintenance. Any errors in the segmentation step will be reflected in all subsequent analysis processes.

A common problem for all such background maintenance schemes is the so-called “ghost” problem. Consider a case where an object that was in the background starts moving, such as a parked car leaving. The result is a ghost target where the background, still showing the parked car, is now different from the current view of an empty space. If the background maintenance process is unable to detect that the target is a ghost there is a deadlock. That area of the scene will not update in the background because there is a target; and there is a target because the background has not been updated. Thus “ghost” images are the captured scene images of objects that were in an adaptive background of the scene but have started moving.

Schemes of background/foreground comparison using video input can determine exactly where there are background/foreground differences. However, the location of the differences is the same whether the object is a real object in the foreground or a ghost in the background. A machine-implemented (computer-driven) system conventionally lacks the ability to recognize the existence of ghost images in an image background because the system may fail to provide current accuracy of background maintenance. By comparison, a human observer has no problem making the distinction because a ghost target is obviously “in” the background image, and just as obviously not “in” the foreground image.

The existing state-of-the-art is for a system to examine the suspect target for pixel level motion and to operate the assumption that only ghost targets have no motion. This scheme is computationally expensive and can fail when a real target stops moving, such as a lurking person trying to avoid being seen.

See an often-referenced paper on this topic, Detecting Moving Objects, Ghosts and Shadows in Video Streams by Rita Cucchiara, Costantino Grana, Massimo Piccardi, and Andrea Prati, found on the web at: http://imagelab.ing.unimo.it/pubblicazioni/pubblicazioni/pami_sakbot.pdf

This paper teaches to measure the average optical flow with the rule that moving objects have “significant motion.”

A review of the current state of segmentation is: Robust Techniques for Background Subtraction in Urban Traffic Video by Sen-Ching S. Cheung and Chandrika Kamath, found on the web at: http://www.llnl.gov/case/sapphire/pubs/UCRL-CONF-200706.pdf This paper examines the literature for different background maintenance techniques and references optical flow as an advanced technique to detect ghosts.

Techniques for dealing with image ghosting according to the prior art have assumed that if there is a difference as between images segmented in the foreground as compared with the background, then an object must exist in the foreground even if not present in the background. But such approach is not able to determine whether the image ghost has existed in the foreground or background

or maybe both, or whether the ghost results from movement within the background. Such techniques fail to mimic human visualization and analysis of the scene, and have not provided operation analogous to human perception of “looking for an outline” of the object in both the background and foreground images.

### SUMMARY OF THE INVENTION

The present invention, which takes an approach different from the known art, is particularly useful as an improvement of the system and methodology disclosed in a copending patent application owned by the present applicant's assignee/intended assignee, namely application Ser. No. 09/773,475, filed Feb. 1, 2001, Published as Pub. No.: US 2001/0033330 A1, Pub. Date: Oct. 25, 2001, entitled System for Automated Screening of Security Cameras, and hereinafter referred to the PERCEPTRAK disclosure or system, and herein incorporated by reference. The term PERCEPTRAK is a registered trademark (Regis. No. 2,863,225) of Cernium, Inc., applicant's assignee/intended assignee, to identify video surveillance security systems, comprised of computers; video processing equipment, namely a series of video cameras, a computer, and computer operating software; computer monitors and a centralized command center, comprised of a monitor, computer and a control panel.

Software-driven processing of the PERCEPTRAK system performs a unique function within the operation of such system to provide intelligent camera selection for operators, resulting in a marked decrease of operator fatigue in a CCTV system. Real-time video analysis of video data is performed wherein at least a single pass of a video frame produces a terrain map which contains elements termed primitives which are low level features of the video. Based on the primitives of the terrain map, the system is able to make decisions about which camera an operator should view based on the presence and activity of vehicles and pedestrians and furthermore, discriminates vehicle traffic from pedestrian traffic. The PERCEPTRAK system provides a processor-controlled selection and control system (“PCS system”), serving as a key part of the overall security system, for controlling selection of the CCTV cameras. The PERCEPTRAK PCS system is implemented to enable automatic decisions to be made about which camera view should be displayed on a display monitor of the CCTV system, and thus watched by supervisory personnel, and which video camera views are ignored, all based on processor-implemented interpretation of the content of the video available from each of at least a group of video cameras within the CCTV system. The PERCEPTRAK system uses video analysis techniques which allow the system to make decisions automatically about which camera an operator should view based on the presence and activity of vehicles and pedestrians. Because vehicles are often the most common subject of interest in a background video, it is important that the system be able to deal with ghosting.

The present methodology and system improvement for ghost detection mimics the human perception of “looking for an outline” of the object in both the background and foreground images. If an outline is found in the foreground image, the target is determined to be real. If an outline is found in the background image, then the target is determined to be a ghost.

The new method can discriminate between real and ghost targets in a single frame resulting in fast, accurate background maintenance.

Among the many advantages of the invention are that a machine-implemented video security or surveillance system is enabled to determine with a high degree of reliability whether, with respect to background and foreground images, there are ghost images, including the capability for determining the probability of such ghosting in both background and foreground images, without human intervention. Certainly one use is for background maintenance in a security or other video system such as the PERCEPTRAK system. Another use, among many possible uses, is to enable such a system to determine, without requiring human supervision, if an object has been removed, as in a museum.

The present invention can be used to great advantage in a security or surveillance system for automatically screening closed circuit television (CCTV) cameras for large and small scale security systems, as employed for example in parking garages, and one example is the PERCEPTRAK system.

In such system, primary software elements which perform a unique function within the operation of the system to provide intelligent camera selection for operators, resulting in a marked decrease of operator fatigue in a CCTV system. Real-time image analysis of video data is performed wherein at least a single pass of a video frame produces a terrain map which contains parameters indicating the content of the video. Based on the parameters of the terrain map, the system is able to make decisions about which camera an operator should view based on the presence and activity of vehicles and pedestrians, furthermore, discriminating vehicle traffic from pedestrian traffic.

Briefly, the system analyzes the behavior of objects such as people and vehicles moving in a video scene such as that containing vehicles and pedestrians, while detecting ghost images, whether in a video scene background or foreground, to take them into account.

More specifically relative to the present disclosure, methodology of the invention involves analysis of the terrain map which contains parameters. The method involves determining by a segmentation step where an outline of an object is predicted. For each row of a target area, a predicted outline on the left side is defined by the left-most segmented pixel. The left-most segmented pixel in both the foreground image and the background image is compared to its adjacent non-segmented pixel. The same procedure is followed on the right side of the target and all rows from both sides of the target are compared. As is clearly shown in FIG. 3, the image where the object is actually located will have greatest differences between the two pixels. By considering the magnitude of differences in regions of predicted outlines, a probability of image ghosting can be determined, and the percentage of likelihood of a ghost in either background or foreground of the image is quantified for further use. Use is made from the terrain map of a horizontal or vertical smoothness parameter, or both. Examination of segmented image portions is conducted by software process to determine existence of an outline such as edge detection or changes in texture.

The general term “software” is herein simply intended for convenience to mean a system and its instruction set or programming, and so, having varying degrees of hardware and software.

### BRIEF DESCRIPTION OF THE DRAWINGS

FIG. 1 is a video scene which illustrates the effect of a car leaving a parking space, comparing the difference in video background where a car that was in the background starts moving, such as a parked car leaving, with the video background showing a “ghost” target where the background, still showing the parked car, is now different from the current view of an empty space.

FIG. 2 is a video scene to illustrate a method, according to the present disclosure, of looking for a ghost outline, and also shows foreground, background and segmented buffers in the same relationship as for the parking example of FIG. 1, and adds two new images of the horizontal smoothness of the foreground and background images.

FIG. 3 is an image view which expands the area of FIG. 2 where an outline is predicted by a segmentation step to illustrate how an outline is detected for ghost detection purposes.

### DETAILED DESCRIPTION OF PRACTICAL EMBODIMENT

The present disclosure describes an inventive “outline” feature. In simplest terms, rather than examining pixel values over time, this invention mimics the human perception of “looking for” an outline of the object in both the background and foreground images. If an outline is found in the foreground image, the target is determined to be real. If an outline is found in the background image, then the target is determined to be a ghost. This method can discriminate between real and ghost targets in a single frame resulting in fast, accurate background maintenance.

The outline-finding technology of the present invention can be used with a wide variety of intelligent video surveillance connotes the use of processor-driven, that is, computerized video surveillance involving automated screening of security cameras, as in security CCTV (Closed Circuit Television) systems.

By way of specific example, the present invention may be understood in the context of its incorporation into the PERCEPTRAK system wherein software-driven processing of the system provides intelligent camera selection within the system for the benefit of human system operators or security personnel, resulting in a marked decrease of operator fatigue in a CCTV system.

In the PERCEPTRAK system, real-time video analysis of video data is performed wherein a single pass or at least one pass of a video frame produces a terrain map which contains elements termed primitives which are low level features of the video. Based on the primitives of the terrain map, the system is able to make decisions about which camera an operator or security should view based on the presence and activity of vehicles and pedestrians and furthermore, discriminates vehicle traffic from pedestrian traffic. A processor-controlled selection and control system (“PCS system”), serves as a key part of the overall security system, for controlling selection of the CCTV cameras. The PCS system is implemented to enable automatic decisions to be made about which camera view should be displayed on a display monitor of the CCTV system, and thus watched by supervisory personnel, and which video camera views are ignored, all based on processor-implemented interpretation of the content of the video available from each of at least a group of video cameras within the CCTV system.

Preferably, the PERCEPTRAK system is configured so that, by use of its video analysis techniques, the system can make decisions automatically about which camera an operator should view based on the presence and activity of vehicles and pedestrians. Events are associated with subjects of interest (video targets) which can, for example, in a parking area security system, be both vehicles and pedestrians. Such events can include, but are not limited to, single pedestrian, multiple pedestrians, fast pedestrian, fallen pedestrian, lurking pedestrian, erratic pedestrian, converging pedestrians, single vehicle, multiple vehicles, fast vehicles, and sudden stop vehicle, merely as examples without limiting analysis and reporting of other possible events or activities or attributes of the subjects of interest, which may themselves be many other targets other than, or in addition to, persons and vehicles.

In a typical preferred usage of the Perceptrak system, including ghost detection in accordance with the present invention, it is desired that video analysis techniques of the system can discriminate vehicular traffic from pedestrian traffic by maintaining an adaptive background and segmenting (which is to say, separating from the background) moving targets. Vehicles are distinguished from pedestrians based on multiple factors, including the characteristic movement of pedestrians compared with vehicles, i.e., pedestrians move their arms and legs when moving but vehicles maintain the same shape when moving. Other useful factors include the aspect ratio and object smoothness. For example, pedestrians are taller than vehicles and vehicles are “smoother” than pedestrians. In the PERCEPTRAK system, the video analysis for such identification purposes is performed by the processor on the terrain map primitives.

In such system, track moving objects by detecting the differences between the current view of a CCTV camera and a background image. The analysis step of creating the background image from a series of video frames is referred to as background maintenance. The analysis step of comparing the current view to the background is referred to as segmentation. The accuracy of any intelligent video system is limited by the accuracy of the background maintenance. Any errors in the segmentation step will be reflected in all subsequent analysis processes. It can be understood why this would occur. Consider, for example, the case where an object in a video scene that was in the background starts moving, such as a parked car leaving. The background video may be archived with less frequency than active subjects in the foreground. The result is a ghost target where the background, still showing the parked car, is now different from the current, or actual, view of an empty space. If the background maintenance process is unable to detect that the target is a ghost there can be a system deadlock, in that such an area of the scene will not update in the background because there is a target; and there is a target because the background has not been updated.

Although schemes of background/foreground comparison using video input can determine exactly where there are background/foreground differences, the location of the differences is nevertheless the same whether the object is a real object in the foreground or a ghost in the background. A conventional machine-implemented (computer-driven) system typically lacks an ability to recognize the existence of ghost images in ah image background because the system can fail to provide current accuracy of background maintenance.

By comparison, a human observer has little difficulty in making the distinction because a ghost target and a real target because the ghost evidently “in” the background image, and just as evidently not “in” the foreground image.

According to the present disclosure, an adaptive background maintenance of the system “blends in” the differences between the current frame and the background frame over time except where a target exists.

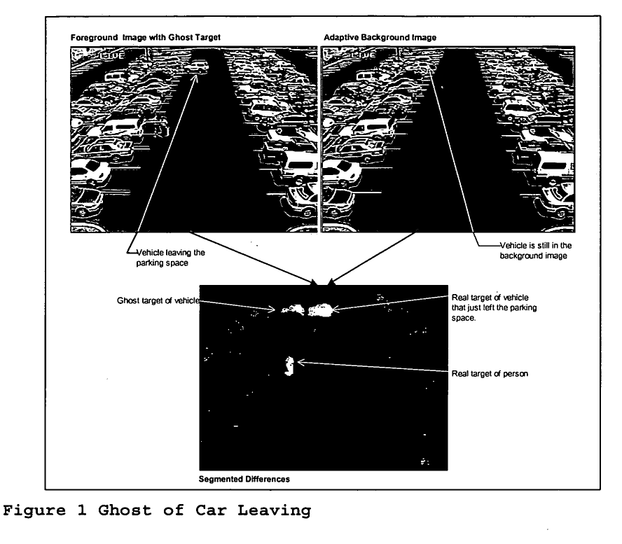

With reference to FIG. 1, note that in the segmented differences image in FIG. 1 there is no information about which buffer contains the actual object, just that the foreground and background images are different. To quickly update the adaptive background the system needs to determine which of the targets are real, and which are ghosts.

The real world example of a ghost image in FIG. 1 has a cluttered background where the ghost car is intermingled with other cars. To clearly illustrate the method of looking for the ghost outline, a simple example was created with an empty vase and a bouquet of nodding wild onions on the inventor's table.

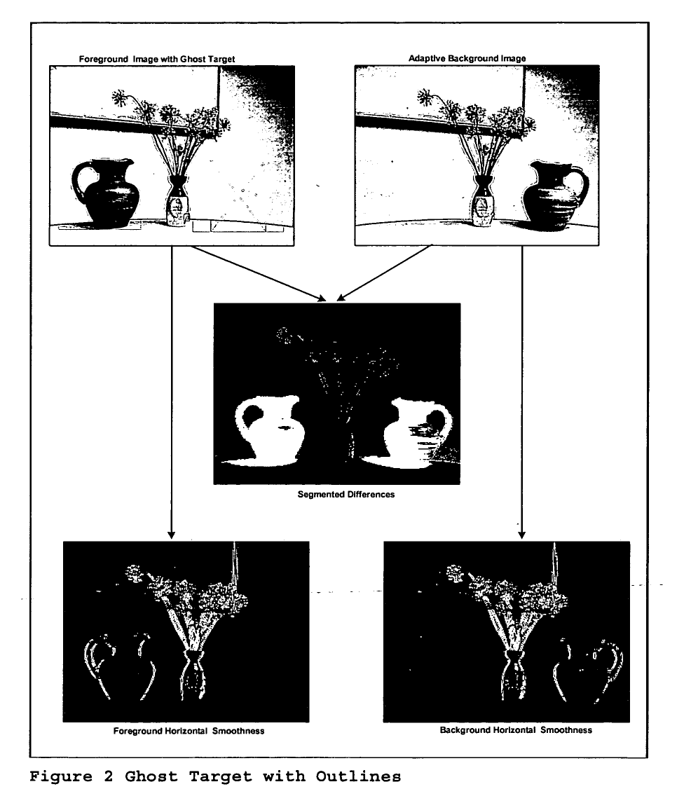

FIG. 2 shows the foreground, background and segmented buffers in the same relationship as the parking example of FIG. 1, and adds two new images of the horizontal smoothness of the foreground and background images. The horizontal smoothness elements are elements of the Terrain Map explained below.

Note that in FIG. 2, the box on the right of the foreground image has an X in the target area indicating that the ghost detection algorithm disclosed here has determined that the target on the right of the bouquet is a ghost target. The vase on the left of the bouquet has a box indicating the boundaries of a real target.

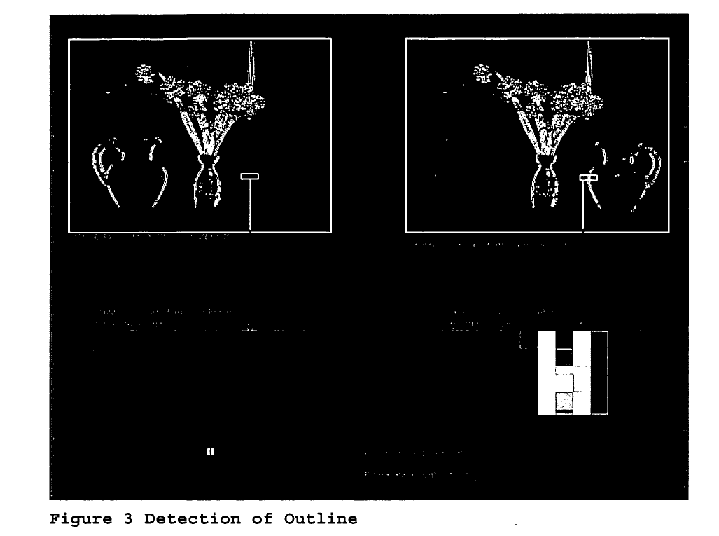

FIG. 3 expands the area of FIG. 2 where an outline is predicted by the segmentation step to illustrate how an outline is detected. For each row of the target area, the predicted outline on the left side is defined by the left-most segmented pixel. The left-most segmented pixel in both the foreground image and the background image is compared to its adjacent non-segmented pixel. The same procedure is followed on the right side of the target and all rows from both sides of the target are compared. As is clearly shown in FIG. 3, the image where the object is actually located will have greatest differences between the two pixels. In this example, the target on the right of FIG. 2 is detected as a ghost because its outline is in the background.

Terrain Map Elements

The HorizontalSmoothness images of FIGS. 2 and 3 are elements of a Terrain Map which is an image space optimized for machine vision. The Terrain Map is the subject of the PERCEPTRAK patent application Ser. No. 09/773,375. A Terrain Map has primitive data associated with pixels and pixel neighborhoods.

The horizontal smoothness images in this document are Transformations of the horizontal smoothness elements of a terrain map. The horizontal smoothness values have been converted to gray scales and multiplied by four to aid human visualization. Other technologies could be used to measure the existence of an outline such as edge detection or changes in texture.

In said Terrain Map each of the map elements contain symbolic information describing the conditions of that part of the image in much the same way as a geographic terrain map represents the lay of the land. Hence the names of the Terrain Map elements:
AverageAltitude is an analog of altitude contour lines on a terrain map. Or when used in the color space, the analog for how much light is falling on the surface.
DegreeOfSlope is an analog of the distance between contour lines on a terrain map. (Steeper slopes have contour lines closer together.)
DirectionOfSlope is an analog of the direction of contour lines on a map such as a south-facing slope.
HorizontalSmoothness is an analog of the smoothness of terrain traveling North or South.
VerticalSmoothness is an analog of the smoothness of terrain when traveling East or West.
Jaggyness is an analog of motion detection in the retina or motion blur. The faster objects are moving the higher the Jaggyness score will be.
DegreeOfColor is the analog of how much color there is in the scene where both black and white are considered as no color. Primary colors are full color.
DirectionOfColor is the analog of the hue of a color independent of how much light is falling on it. For example a red shirt is the same red in full sun or shade.

The PERCEPTRAK system carries out real-time analysis of video image data for subject content involving performing at least one pass through a frame of said video image; and generating said Terrain Map from said at least one pass through said frame of said video image data, where Terrain Map comprises a plurality of parameters wherein the parameters indicate the content of the video image data, and the paramaters include at least Average Altitude; Degree of Slope; Direction of Slope; and Smoothness.

Taking into consideration also the parameters Jaggyness; Color Degree; and Color Direction can provide further utility for the PERCEPTRAK system but are not necessary in some contexts nor required for ghost detection in accordance with the present disclosure.

Ghost detection as herein described is primarily concerned with Smoothness which includes Horizontal Smoothness and Vertical Smoothness.

The three elements used for the color space, AverageAltitude, DegreeOfColor, and DirectionOfColor represent only the pixels of the element while the other elements represent the conditions in the neighborhood of the element.

In the present embodiment, one Terrain Map element represents four pixels in the original raster diagram and a neighborhood or kernel of a map element consists of an eight by eight matrix surrounding the four pixels. Neighborhoods of other sizes can instead be selected if appropriate.

HorizontalSmoothness is a measurement of texture which is sensitive to variations in values from left to right in the image. The Terrain Map also includes similar elements VerticalSmoothness which would be useful in looking for target outlines on the top and bottom. However, looking just on the left and right yields accurate results.

Source Code

The following code fragment for ghost detection is extracted from the running PERCEPTRAK system that creates the images of FIGS. 1, 2 and 3. The “map” reference in the code refers to Terrain Map elements. The names of the other variable are meaningful, and should be understood in context by persons concerned with the art of video image processing for image segmenting, especially for security purposes.

The following code calculates the variable ItsaGhostScore where a score of 50 is ambiguous (50%) and a score of 100 is 100% sure to be a ghost.

TargetHeight = (MapTop − MapBottom) + (long)1;
TargetWidth = (MapRight − MapLeft) + (long)1;
RowsPerArea = TargetHeight /VerticalAreas;
//VerticalAreas is a global

// constant of five for number of areas per
target

VerAreaNum = (long)0; // Initial set at the bottom

| | |
|---|---|
| RowsSoFarInThisArea = (long)0; | // Initial set so the first row will |

// be calculated as one

GapEles = 0;
for (MapRow = MapBottom; MapRow <= MapTop; ++MapRow)
{

// find the left most segmented map element
LeftMostSegmented = MapRight; // in case something goes sour
LeftMostNonSegmentedOffset = MapSizeX * MapRow+MapRight;
LeftMostSegmentedOffset = LeftMostNonSegmentedOffset;
MapOffset = (MapSizeX * MapRow ) + MapLeft;
for (ThisEle = MapLeft; ThisEle <= MapRight; ++ ThisEle)
{

ThisMapElePtr = TestTerrainMapPtr + MapOffset;
if (ThisMapElePtr−>TargetNumber EQUALS TargetNumber)
{ // this is the left most segmented map element
LeftMostSegmented = ThisEle; //referenced to full MapSizeX

eftMostSegmentedOffset = MapOffset;
break;

}
else

LeftMostNonSegmentedOffset = MapOffset;

++MapOffset;

} // end of looking for the left most segmented map element
// Check the ghost score
if(LeftMostSegmented NOTEQUAL MapLeft)
{

BackgndLastNonSegmented = BackGndTerrainMapPtr +

LeftMostNonSegmentedOffset;

BackgndTargetEdge = BackGndTerrainMapPtr +

LeftMostSegmentedOffset;

ForegndLastNonSegmented = TestTerrainMapPtr +

LeftMostNonSegmentedOffset;

ForegndTargetEdge = TestTerrainMapPtr +

LeftMostSegmentedOffset;

TargetEdgeInBackground =

abs(BackgndLastNonSegmented−>AverageAltitude
− BackgndTargetEdge−>AverageAltitude)

+

abs(BackgndLastNonSegmented−>HorizSmoothness

− BackgndTargetEdge−>HorizSmoothness);

TargetEdgeInForeground =

abs(ForegndLastNonSegmented−>AverageAltitude
− ForegndTargetEdge−>AverageAltitude)

+

abs(ForegndLastNonSegmented−>HorizSmoothness

− ForegndTargetEdge−>HorizSmoothness);

if (TargetEdgeInBackground > TargetEdgeInForeground)

++SamplesWithEdgeInBackground;

++EdgeSamplesChecked;

}
// find the right most segmented map element
RightMostSegmented = MapLeft; // in case something goes sour
RightMostNonSegmentedOffset = (MapSizeX * MapRow);
RightMostSegmentedOffset = RightMostNonSegmentedOffset;
MapOffset = (MapSizeX * MapRow) + MapRight;
for (ThisEle = MapRight; ThisEle >= MapLeft; −−ThisEle)
{

ThisMapElePtr = TestTerrainMapPtr + MapOffset;
if (ThisMapElePtr−>TargetNumber EQUALS TargetNumber)
{ // this is the left most segmented map element

RightMostSegmented = ThisEle; // referenced to full

MapSizeX

RightMostSegmentedOffset = MapOffset;
break;

}
else

RightMostNonSegmentedOffset = MapOffset;

−−MapOffset;

} // end of looking for the right most segmented map element
// check the ghost score
if (RightMostSegmented NOTEQUAL MapRight)
{

BackgndLastNonSegmented = BackGndTerrainMapPtr +

RightMostNonSegmentedOffset;

BackgndTargetEdge = BackGndTerrainMapPtr +

RightMostSegmentedOffset;

ForegndLastNonSegmented = TestTerrainMapPtr +

RightMostNonSegmentedOffset;

ForegndTargetEdge = TestTerrainMapPtr +

RightMostSegmentedOffset;

TargetEdgeInBackground =

```
abs(BackgndLastNonSegmented−>AverageAltitude −
  BackgndTargetEdge−>AverageAltitude) +
abs(BackgndLastNonSegmented−>HorizSmoothness
  BackgndTargetEdge−>HorizSmoothness );
```

TargetEdgeInForeground =
abs(ForegndLastNonSegmented−>AverageAltitude −

ForegndTargetEdge−>AverageAltitude) +
abs(ForegndLastNonSegmented−>HorizSmoothness
− ForegndTargetEdge−>HorizSmoothness);

if (TargetEdgeInBackground > TargetEdgeInForeground)

++SamplesWithEdgeInBackground;

++EdgeSamplesChecked;

}

if (EdgeSamplesChecked > (long)0)

ItsaGhostScore = ((long)100 *
SamplesWithEdgeInBackground)/EdgeSamplesChecked;

else

ItsaGhostScore = (long)100; // It may not be a ghost but it's not a
real thing

The foregoing embodiment shows the application of principles of the invention using smoothness measurement, here specifically illustrating use of the horizontal smoothness measurement or parameter of the so-called terrain map created by the system. The use of the terrain map parameter horizontal smoothness to look for the top and bottom outlines has been discussed. Such horizontal smoothness is a measurement of texture sensitive to variations in values from left to right in the image. In this regard, it is found that looking on the left and right has accurate results in the context illustrated.

Of course, the image terrain map includes as well comparable parameters or elements of vertical smoothness which can be used to look for target outlines on the top and bottom, as in an image visual context where variations in values between top and bottom are significant.

One might also use the present analysis techniques to determine change in pixel value or measured slope, and one may in accordance with the present disclosure employ software programming comparable to that here discussed to look at top and bottom outlines of objects within a scanned image, so as in comparable manner to detect an outline in the location predicted by the difference between foreground and background of the scanned image; and one may also implement the system by taking into consideration of vertical smoothness.

The present inventive concepts can also be implemented only with pixels as disclosed herein and using examination in accordance with the principles of the software source code here disclosed of the terrain map parameter Average Altitude (brightness) without departing from the principles of the invention.

As various modifications could be made in the constructions and methods herein described and illustrated without departing from the scope of the invention, it is intended that all matter contained in the foregoing description or shown in the accompanying drawings shall be interpreted as illustrative rather than limiting.

Thus, the breadth and scope of the present invention should not be limited by any of the above-described exemplary disclosures or embodiment(s), but should be defined only in accordance with the claims and their equivalents.

What is claimed is:

1. A method of video image ghost detection for use in a video surveillance system using real-time image analysis of video data wherein at least one pass of a video frame produces a terrain map containing parameters indicating content of background and foreground video images, said method comprising
(a) measuring one or more parameters in the terrain map for smoothness in segmentation to predict where an outline of an object is predicted,
(b) considering the magnitudes of differences in regions of predicted object outlines;
(c) determining from the magnitudes of differences in regions the probability of image ghosting therein in either background or foreground images or both.

2. A method as set forth in claim 1 further comprising calculating from said magnitudes of differences the percentage of likelihood of a ghost in either background or foreground of the image.

3. A method as set forth in claim 2 comprising quantifying said percentage for further use.

4. A method as set forth in claim 1 wherein step (a) is carried out by comparing a horizontal or vertical smoothness parameter of the terrain map.

5. A method as set forth in claim 4 wherein step (b) is carried out by system software examination of segmented image portions to determine existence of an object outline by edge detection or changes in texture.

6. A method as set forth in claim 5 wherein step (b) is carried out in both background and foreground images and magnitudes of differences between background and foreground are compared to determine if an image ghost appears in either the background or foreground or both.

7. A method as set forth in claim 6, wherein steps (b) and (c) are carried out for each row of a target area within the background and foreground images, by software sequential steps.

8. A method as set forth in claim 6, wherein a predicted object outline on the left side is defined by the left-most segmented pixel, and wherein the left-most segmented pixel in both the foreground image and the background image is compared to its adjacent non-segmented pixel, and further wherein the same procedure is followed on the right side of the target and all rows from both sides of the target are compared.

9. In a video system for automatically screening video cameras wherein software elements provide real-time image analysis of video data is performed, and wherein at least a single pass of a video frame produces a terrain map which contains parameters indicating the content of the video, a method of video image ghost detection comprising:
(a) measuring one or more parameters in the terrain map for smoothness in segmentation to predict where an outline of an object is predicted,
(b) considering the magnitudes of differences in regions of predicted object outlines;
(c) determining from the magnitudes of differences in regions the probability of image ghosting therein in either background or foreground images or both.

10. A method as set forth in claim 9 further comprising calculating from said magnitudes of differences the percentage of likelihood of a ghost in either background or foreground of the image.

11. A method as set forth in claim 10 comprising quantifying said percentage for further use in said system.

12. A method as set forth in claim 9 wherein step (a) is carried out by comparing a horizontal or vertical smoothness parameter of the terrain map.

13. A method as set forth in claim 12 wherein step (b) is carried out by system software examination of segmented image portions to determine existence of an object outline by edge detection or changes in texture.

14. A method as set forth in claim 13 wherein step (b) is carried out in both background and foreground images and magnitudes of differences between background and foreground are compared to determine if an image ghost appears in either the background or foreground or both.

15. A method as set forth in claim 14, wherein steps (b) and (c) are carried out for each row of a target area within the background and foreground images, by software steps.

16. A method as set forth in claim 15, wherein a predicted object outline on the left side is defined by the left-most segmented pixel, and wherein the left-most segmented pixel in both the foreground image and the background image is compared to its adjacent non-segmented pixel, and further wherein the same procedure is followed on the right side of the target and all rows from both sides of the target are compared.

17. A method of video image ghost detection for use in a video system using real-time image analysis of video data wherein a video frame is analyzed to provide a set of data containing parameters indicating content of background and foreground video images, said method comprising
(a) measuring one or more parameters to predict where an outline of an object is predicted,
(b) considering the magnitudes of differences in regions of predicted object outlines;
(c) determining from the magnitudes of differences in regions the probability of image ghosting therein in either background or foreground images or both.
